(19) United States
(12) Patent Application Publication
(10) Pub. No.: US 2025/0296818 A1
(43) Pub. Date: Sep. 25, 2025

(54) Winch

(71) Applicant: Caiping Su, Yuhuan City (CN)

(72) Inventor: Caiping Su, Yuhuan City (CN)

(21) Appl. No.: 18/830,583

(22) Filed: Sep. 11, 2024

(30) Foreign Application Priority Data
Mar. 20, 2024 (CN) 202410322505.3

(51) Int. Cl. B66D 1/02

(52) U.S. Cl. CPC B66D 1/02; B66D 2700/01

(57) ABSTRACT

A winch, comprising: a main frame and a spool rotatably mounted on the main frame, a first end of the spool being connected with an uni-directional locking component, while a second end of the spool serving as a mounting end; wherein a uni-directional drive component assembled by a drive bracket, a ratchet, a rotatable drum, and a pawl mating with the ratchet, the rotatable drum is fixedly connected to the drive bracket, the uni-directional drive component is sleeved onto the mounting end of the spool via the ratchet, the ratchet is radially provided with at least one mounting hole, and the ratchet is fixedly connected to the mounting end of the spool by at least one fastener inserted through the at least one mounting hole. The present winch reduces assembly steps for installing the uni-directional drive component onto the spool, thereby making assembly more convenient.

### RELATED APPLICATIONS

This application claims priority to Chinese Patent Application No. 202410322505.3, filed Mar. 20, 2024.

The above applications and all patents, patent applications, articles, books, specifications, other publications, documents, and things referenced herein are hereby incorporated herein in their entirety for all purposes. To the extent of any inconsistency or conflict in the definition or use of a term between any of the incorporated publications, documents, or things and the text of the present document, the definition or use of the term in the present document shall prevail.

### TECHNICAL FIELD

The present disclosure relates to the technical field of bundling equipment, and particularly to a winch.

### BACKGROUND

A winch is an equipment used for traction or lifting heavy objects to facilitate lifting or hauling items. A conventional winch, such as one disclosed in Chinese Patent Literature (Granted Patent Publication Number: CN201784814U), comprise: a U-shaped bracket; a rotatable belt shaft mounted on the bracket, with both ends of the belt shaft extending beyond the bracket, a portion of one end of the belt shaft extending beyond the bracket having a rotation mechanism, while a portion of the other end of the belt shaft extending beyond the bracket having a ratchet that is sleeved onto and fixedly connected to the belt shaft and rotates together with the belt shaft; and, a pawl hinged to the bracket and mating with the ratchet, allowing uni-directional rotation of the belt shaft during a tightening process to gradually tightening a bundling strap. However, when using such a conventional winch, the rotation mechanism directly fixed to the belt shaft necessitates repetitive insertion and removal of a pry bar into an insertion hole of the rotation mechanism during the process of tightening the bundling strap. This complexity complicates operations and significantly reduces work efficiency.

To address these issues, one embodiment of a winch with a rapid rotation mechanism has been developed, such as one disclosed in Chinese patent literature Chinese Patent Literature (Granted Patent Publication Number: CN202897890U), wherein, the rapid rotation mechanism is provided at an end of the belt shaft of the winch, and comprises a fixing seat and a rotatable drum; a uni-directional mechanism using ratchet pawl for engagement is provided between the rotatable drum and the belt shaft; the fixing seat comprises a disc-shaped base and an annular clamp ring which are securely connected by a connecting pin; a pawl is hinged onto the connecting pin. The base is welded and fixed to the end of the belt shaft, while the rotatable drum is welded to the ratchet. During reciprocating rotation of the rotatable drum, the aforementioned uni-directional mechanism allows for continuous uni-directional rotation of the belt shaft. Although this winch has the advantage of convenient operation, it still has the following shortcomings:

When assembling this winch, it is necessary to first weld an uni-directional drive assembly—consisting of a ratchet and a pawl—onto the end of the belt shaft facing away from the rapid rotation mechanism, before installing the rapid rotation mechanism. Next, in an installation procedure of the rapid rotation mechanism, due to a close proximity between the base of the rapid rotation mechanism and the U-shaped bracket, it is necessary to first weld the base to the belt shaft, ensuring that the welding of the base is conducted without obstruction of any component on the side of the base facing away from the U-shaped bracket, which facilitates welding the base securely to the belt shaft using a welding gun. After the base is welded, the remaining components such as the clamp ring, the rotatable drum, the ratchet, the pawl, and others are manually assembled into a single unit that is then wholly aligned and connected to the base to finalize the assembly of this winch.

Since the assembly of this winch requires first welding the base to the belt shaft and then assembling a series of components (such as the clamp ring, the ratchet, and the pawl) onto the base, relatively numerous steps are involved in the assembly of this winch; moreover, welding equipment is required, making the assembly cumbersome and inefficient; additionally, after welding the base, it is necessary to first install four connecting pins onto the clamp ring, sleeve a torsion spring and a pawl onto each connecting pin, then align and connect the clamp ring to the base, and finally connect each of the four connecting pins into a corresponding mounting hole on the base. However, during this assembly process, when an operator aligns and installs one of the connecting pins into a mounting hole on the base, the pawls and torsion springs on the other connecting pins may become misaligned or even slip off because the other connecting pins have not yet been connected to the base, making the operation rather cumbersome and significantly affecting assembly efficiency.

### SUMMARY

An objective of one embodiment of the present disclosure is to provide a winch, which resolves the above technical problem in the prior art, i.e., the cumbersome assembly issues associated with existing winches.

The objective of the present disclosure can be achieved by the following technical solution. One embodiment of a winch, comprisies a main frame and a spool rotatably mounted on the main frame, a first end of the spool being connected with an uni-directional locking component capable of allowing the spool to rotate only in one direction, while a second end of the spool serving as a mounting end; wherein a uni-directional drive component assembled by a drive bracket, a ratchet, a rotatable drum, and a pawl mating with the ratchet, the rotatable drum is fixedly connected to the drive bracket, the uni-directional drive component is sleeved onto the mounting end of the spool via the ratchet, the ratchet is radially provided with at least one mounting hole, and the ratchet is fixedly connected to the mounting end of the spool by at least one fastener inserted through the at least one mounting hole.

In use of the present winch, forward rotation of the rotatable drum causes the drive bracket—which is fixedly connected to the rotatable drum—to rotate together, while the pawl remaining engaged within a tooth groove of the ratchet, thereby driving both the ratchet and the spool to rotate and wind a bundling strap onto the spool; when the rotatable drum rotates in a reverse direction, the pawl slides over the ratchet, allowing the drive bracket to rotate freely relative to the spool, but the spool remains stationary during the reverse rotation of the rotatable drum due to the uni-directional locking component provided at the first end of the spool and only permitting uni-directional rotation of the spool. Therefore, by continuously reciprocating the rotation of the rotatable drum via the drive bracket, the spool can be driven to rotate uni-directionally, gradually tightening the bundling strap and facilitating the bundling operation.

When assembling the present winch, an operator simply needs to first assemble the drive bracket, the ratchet, the rotatable drum, and the pawl to form the uni-directional drive component; next, the operator aligns the inner hole of the ratchet on the uni-directional drive component with the spool so as to sleeve the uni-directional drive component onto the spool; afterward, the operator installs the fastener(s) on the ratchet to complete the assembly process. Apparently, this assembly method involves simply two steps for installing the uni-directional drive component onto the spool, that is, sleeving the uni-directional drive component onto the spool via the ratchet, and then installing the fastener(s). This two-step procedure eliminates the need for welding the drive bracket to the spool, thus saving welding processes compared to the prior art and reducing assembly steps, thereby making assembly more convenient. Furthermore, during assembly, by first assembling the ratchet and the pawl onto the drive bracket to form the uni-directional drive component and then install the uni-directional drive component as a whole onto the spool, this method ensures that there is no risk of misalignment or slipping of the pawl during installation of the uni-directional drive component onto the spool, making the assembly operation more convenient and efficient.

In one embodiment of the above winch, the mounting end of the spool is provided with at least one positioning hole opposite the at least one mounting hole, the at least one fastener has an outer end with external threads capable of threading into and securing inside the at least one mounting hole, and an inner end capable of inserting into and fitting within the at least one positioning hole.

In this configuration, the fastener(s) is installed using threaded connections, making the installation process of the fastener(s) extremely convenient and effortless. Moreover, positioning the outer end of the fastener(s) inside the mounting hole prevents the outer end of the fastener(s) from protruding onto the ratchet teeth, thereby avoiding interference with the movement of the pawl and ensuring smooth engagement between the a tooth groove of the ratchet and the pawl, thus enhancing the stability and reliability of the winch during use.

In one embodiment of the above winch, an anti-rotation projection is provided on an inner circumferential wall of the ratchet, a limit notch is provided on the mounting end of the spool, the anti-rotation projection on the ratchet is capable of inserting into and fitting within the limit notch.

Through the interaction between the anti-rotation projection and the limit notch, the anti-rotation projection is capable of working together with the fastener(s) to securely fix a circumferential position of the ratchet, thereby ensuring the stability of the installation of the ratchet and the spool, and ensuring consistent rotation of the spool via the ratchet. Moreover, the anti-rotation projection shares load with the fastener(s), reducing the number of the fastener(s) required—potentially to just one or two—to meet the stability requirements for installing the ratchet. This not only decreases the number of the fastener(s) needed but also saves installation time, making the assembly process of this winch more convenient and efficient.

In one embodiment of the above winch, the at least one mounting hole is provided, in a quantity of 2 to 4, on an outer circumferential surface of the ratchet along a circumference of the ratchet.

Directly providing the mounting holes on the outer circumference of the ratchet allows the fastener(s) to be inserted from outside, simplifying installation and tightening of the fastener(s) and enhancing assembly convenience for the winch. Setting the number of the mounting holes to 2 to 4 ensures stable installation of the ratchet without unnecessary fastener(s) that could prolong the assembly process, thereby ensuring both convenience and high efficiency during assembly.

In one embodiment of the above winch, the drive bracket comprises two side plates arranged axially opposite each other and fixedly connected to each other, the ratchet is positioned between the two side plates, a gap between the two side plates is slightly larger than a thickness of the ratchet, each of the two side plates is provided with a bracket hole at a central part of the side plate, both bracket holes being concentric with the inner hole of the ratchet, the mounting end of the spool is rotatably inserted through the bracket holes of the two side plates.

Rotatably inserting the mounting end of the spool through the bracket holes of the two side plates allows the drive bracket to rotate with increased stability and smoothness. Moreover, positioning the ratchet between the two side plates, with the gap between the two side plates being slightly larger than the thickness of the ratchet, enables the ratchet to define the drive bracket's relative position along the spool's axis, thereby limiting axial movement of the drive bracket and preventing the drive bracket from disengaging from the spool.

In one embodiment of the above winch, each of the two side plates has a plurality of protrusions along an edge of the side plate, protrusions on a first side plate correspond one-to-one with protrusions on a second side plate, and a connector is fixedly connected between each pair of corresponding protrusions, a support sleeve is sleeved onto the connector, the support sleeve having two end faces, a first end face abutting against the first side plate, a second end face abutting against the second side plate, the pawl is rotatably sleeved onto the support sleeve and capable of engaging in a tooth groove of the ratchet under action of a torsion spring sleeved onto the support sleeve.

Providing the protrusions can facilitate installing the pawl. The two end of the support sleeve abutting against the respective side plates can define a distance between the two side plates, preventing the two side plates from continually moving closer together and excessively squeezing the ratchet, thereby ensuring smooth rotation of the ratchet relative to the drive bracket.

Typically, the number of the pawls is 2 to 4, and correspondingly, the number of the protrusions on each of the two side plates is the same, i.e., 2 to 4.

In one embodiment of the above winch, an annular dust cover is snap-fittedly connected to the two side plates, a plurality of protruded shielding portions are circumferentially provided on the dust cover and mutually spaced, each of the protruded shielding portions corresponding to each pair of corresponding protrusions on the two side plates and shielding each pair of corresponding protrusions, each of two adjacent protruded shielding portions being connected by a curved shielding portion shielding a gap between edges of the two side plates.

In one embodiment of the above winch, there are two of the at least one mounting holes, and two mounting holes are located on a same diameter direction of the ratchet, there are two of the at least one positioning holes on the spool, and two positioning holes correspond one-to-one with the two mounting holes, the at least one fastener is a pin shaft, with a first end of the at least one fastener capable of being inserted into and secured within a first mounting hole and a corresponding positioning hole, and a second end of the at least one fastener capable of being inserted into and secured within a second mounting hole and the corresponding positioning hole.

In one embodiment of the above winch, the rotatable drum is arranged to be coaxial with the spool, with one end of the rotatable drum being welded to one side of the drive bracket opposite the main frame, and a plurality of insertion holes being provided circumferentially on the rotatable drum and mutually spaced.

In one embodiment of the above winch, the rotatable drum is a metal tube, the rotatable drum is arranged to be perpendicular to the spool, and is fixedly connected to the drive bracket by welding.

Compared to the prior art, the present winch has the following advantages:
1. By continuously reciprocating the rotation of the rotatable drum via the drive bracket, the spool can be driven to rotate uni-directionally, gradually tightening a bundling strap and facilitating a bundling operation.
2. With the design of the present winch, it involves simply two steps for installing the uni-directional drive component onto the spool, that is, sleeving the uni-directional drive component onto the spool via the ratchet, and then installing the fastener(s). This two-step procedure eliminates the need for welding the drive bracket to the spool, thus saving welding processes compared to the prior art and reducing assembly steps, thereby making assembly more convenient.

### BRIEF DESCRIPTION OF THE DRAWINGS

FIG. 1 is a first perspective view of one embodiment of the present winch;

FIG. 2 is a second perspective view of one embodiment of the present winch, from another viewing angle;

FIG. 3 is a partial perspective view of a mounting end of one embodiment of the present winch;

FIG. 4 is a perspective view of a uni-directional drive component in one embodiment of the present winch;

FIG. 5 is an exploded view of the uni-directional drive component in one embodiment of the present winch;

FIG. 6 is a side view of one embodiment of the present winch;

FIG. 7 is a sectional view along direction A-A of FIG. 6;

FIG. 8 is an enlarged view of an area B from FIG. 7;

FIG. 9 is a top view of one embodiment of the present winch;

FIG. 10 is a sectional view along direction C-C of FIG. 9;

FIG. 11 is a perspective view of an assembly process of one embodiment of the present winch;

FIG. 12 is a perspective view of Embodiment II of the present winch;

FIG. 13 is a perspective view of a dust cover in Embodiment II;

FIG. 14 is a perspective view of Embodiment III of the present winch;

FIG. 15 is a front view of Embodiment III of the present winch;

FIG. 16 is a sectional view along direction D-D of FIG. 15;

FIG. 17 is a perspective view of Embodiment IV of the present winch;

FIG. 18 is a perspective view of Embodiment V of the present winch.

### DETAILED DESCRIPTION

Set forth below are specific embodiments of the present disclosure and a further description of the technical solutions of the present disclosure in conjunction with the accompanying drawings, but the present disclosure is not limited to these embodiments.

### Embodiment I

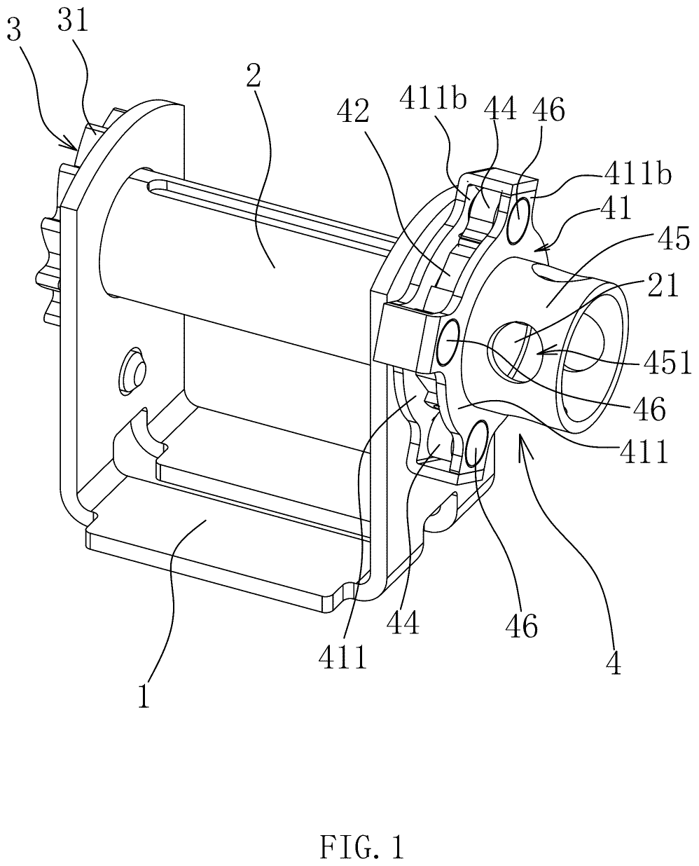

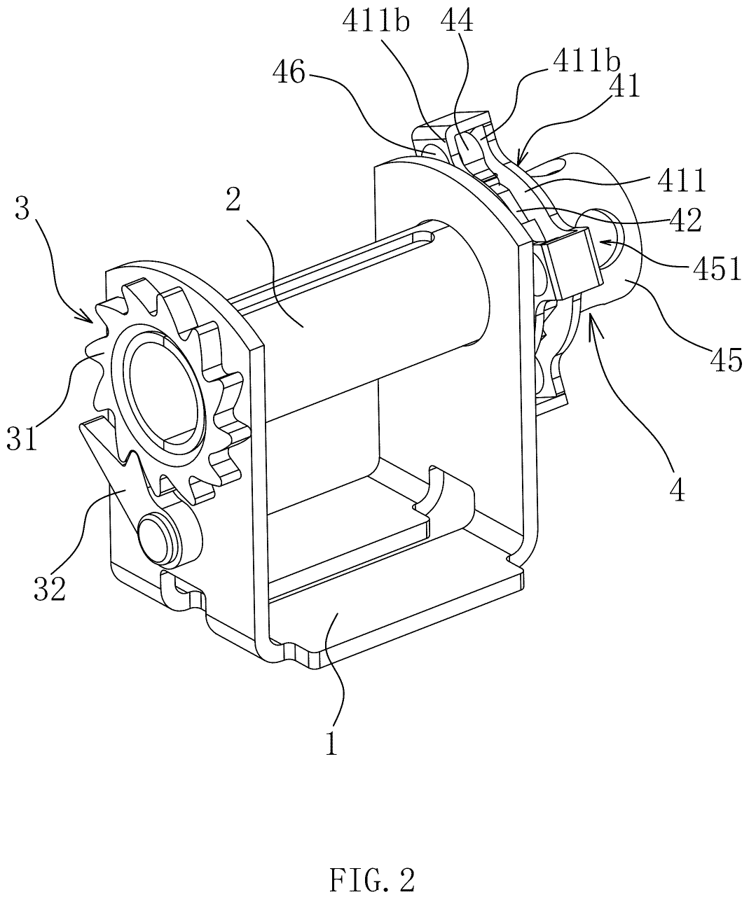

As shown in FIGS. 1 and 2, one embodiment of a winch comprises: a main frame 1 and a spool 2 rotatably mounted on the main frame 1. The main frame 1 is in the form of a U-shaped plate, and two ends of the spool 2 protrude through the main frame 1, a first end of the spool 2 being connected with an uni-directional locking component 3 capable of allowing the spool 2 to rotate only in one direction, while a second end of the spool 2 serving as a mounting end 21; wherein the uni-directional locking component 3 comprises: an anti-loosening ratchet 31 sleeved on and welded to the spool 2, and an anti-loosening pawl 32 mating with the anti-loosening ratchet 31.

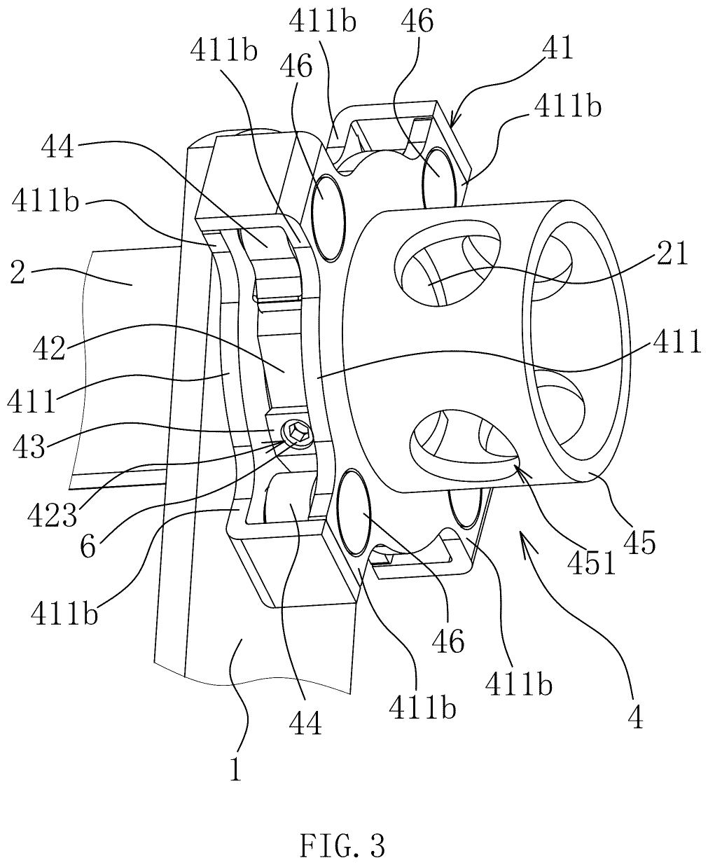

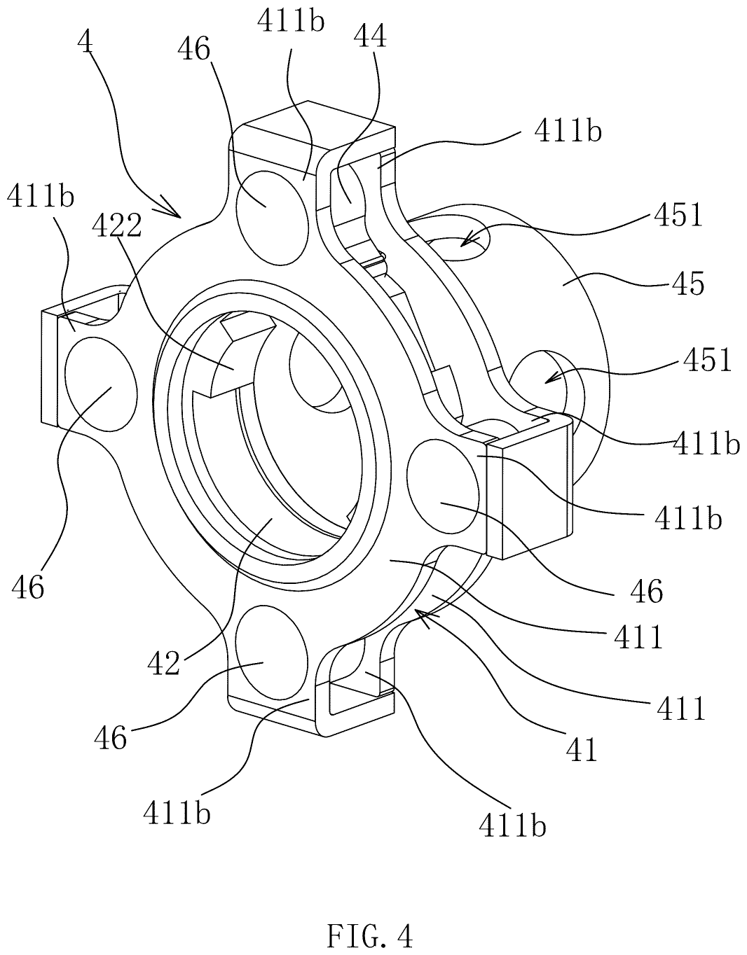

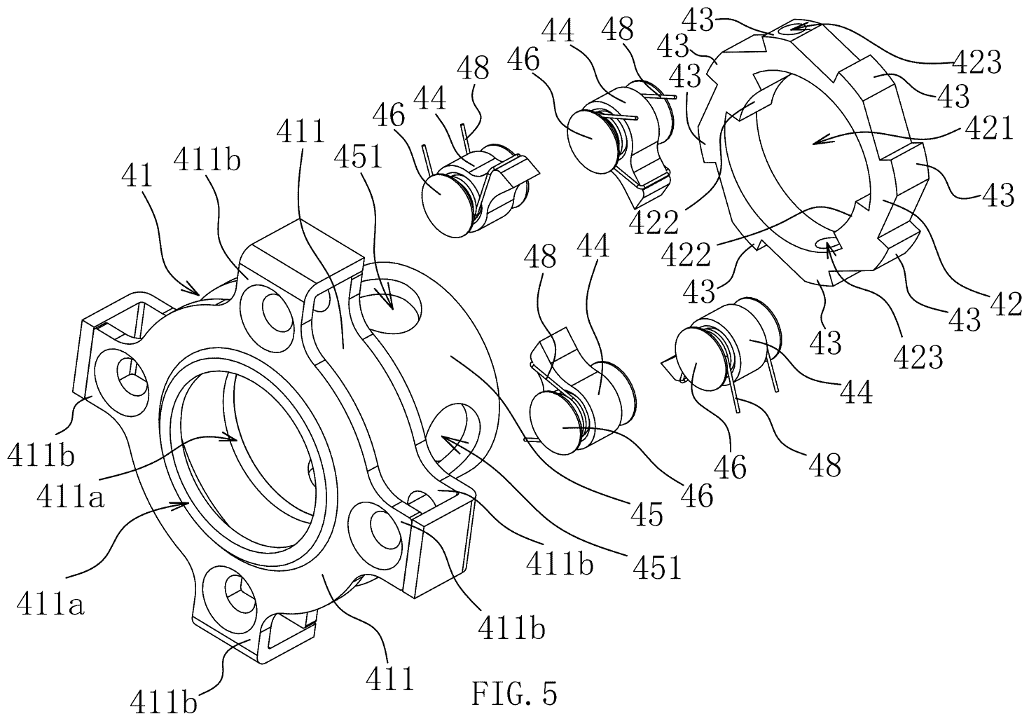

As shown in FIGS. 3, 4, and 5, one embodiment of the winch further comprises a uni-directional drive component 4 assembled by a drive bracket 41, a ratchet 42, a rotatable drum 45, and a pawl 42 mating with the ratchet 44, the rotatable drum 45 is fixedly connected to the drive bracket 41 by welding. The drive bracket 41 comprises two side plates 411 arranged axially opposite each other and fixedly connected to each other, the ratchet 42 is positioned between the two side plates 411. Each of the two side plates 411 has four protrusions 411b along an edge of the side plate 411 and protruding along a diameter of the spool 2; protrusions 411b on a first side plate 411 correspond one-to-one with protrusions 411b on a second side plate 411; typically, the number of the pawls 44 is four, with each pawl 44 being hinged between corresponding pair of protrusions 411b on the side plates 411.

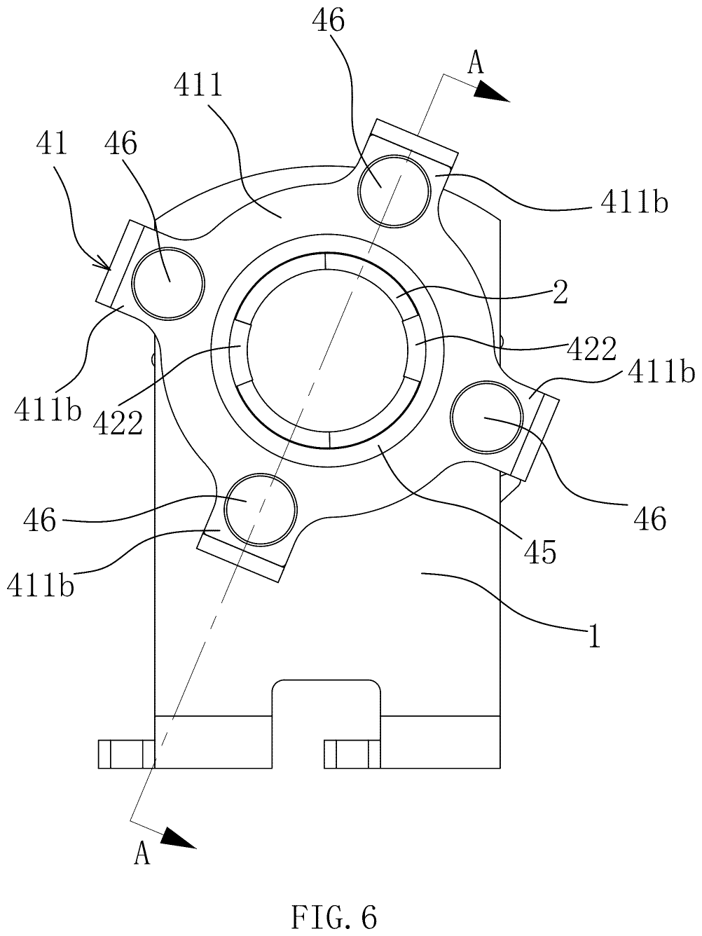

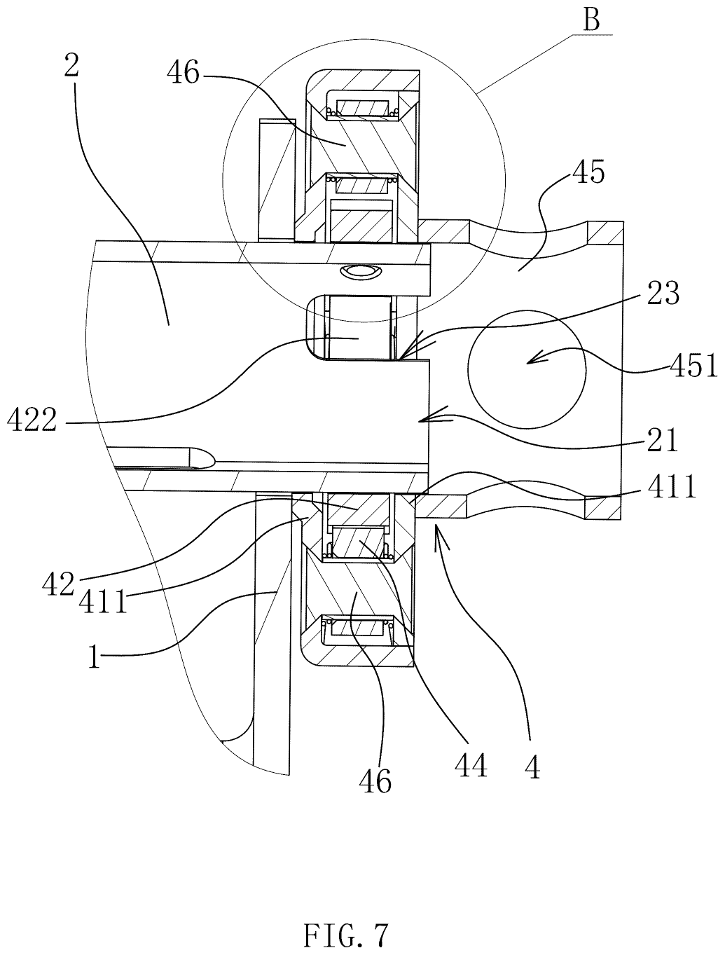

As shown in FIGS. 6 and 7, one embodiment of the rotatable drum 45 is arranged to be coaxial with the spool 2, with one end of the rotatable drum 45 being welded to one side of the drive bracket 41 facing away from the main frame 1, and a plurality of insertion holes 451 being provided circumferentially on the rotatable drum 45 and mutually spaced. The uni-directional drive component 4 is sleeved onto the mounting end 21 of the spool 2 via the ratchet 42, the ratchet 42 is radially provided with two mounting holes 423, and the ratchet 42 is fixedly connected to the mounting end 21 of the spool 2 by two fasteners 6 inserted through the two mounting holes 423 respectively. There is a plurality of ratchet teeth 43 on an outer circumferential surface of the ratchet 42 along a circumference of the ratchet 42. The two mounting holes 423 are respectively provided on the tooth surfaces of the two ratchet teeth 43. The quantity of the mounting hole 423 also maybe 1, 3, or 4, in actual manufacturing.

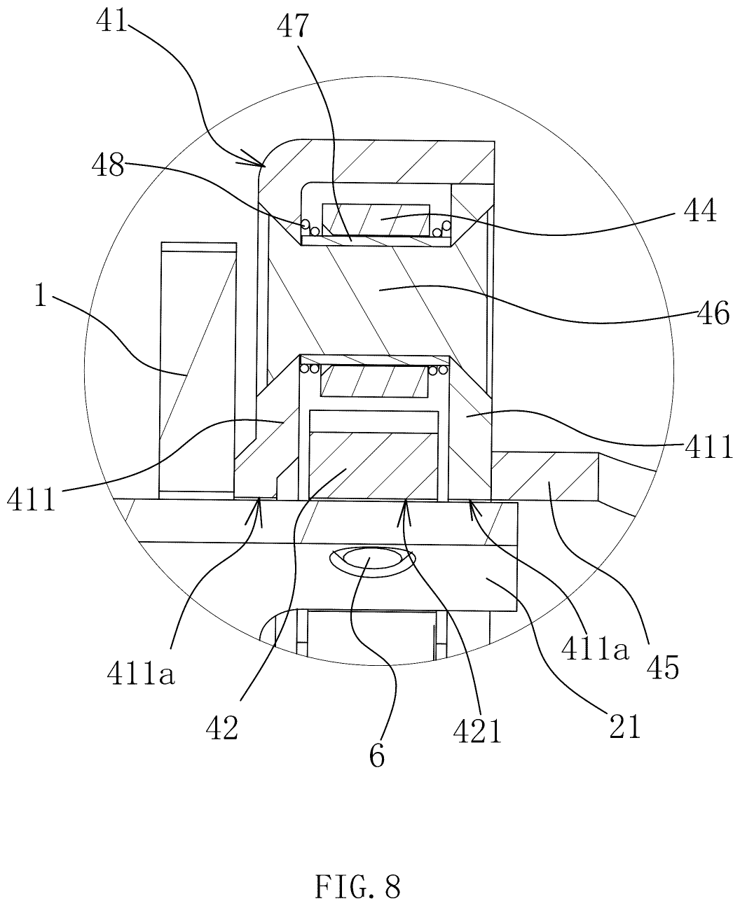

As shown in FIGS. 7 and 8, a gap between the two side plates 411 is slightly larger than a thickness of the ratchet 42, each of the two side plates 411 is provided with a bracket hole 411a at a central part of the side plate 411, both bracket holes 411a being concentric with the inner hole 421 of the ratchet 42, the mounting end 21 of the spool 2 is rotatably inserted through the bracket holes 411a of the two side plates 411. This design enables the ratchet 42 to define a relative position of the drive bracket 41 along an axial direction of the spool 2, thereby limiting the drive bracket 41 from shifting along the axial direction of the spool 2 and ensuring the drive bracket 41 remains attached to the spool 2. A connector 46 is fixedly connected between each pair of corresponding protrusions 411b, a support sleeve 47 is sleeved onto the connector 46, the support sleeve 47 having two end faces, a first end face abutting against the first side plate 411, a second end face abutting against the second side plate 411, the pawl 44 is rotatably sleeved onto the support sleeve 47 and capable of engaging in a tooth groove of the ratchet 42 under action of a torsion spring 48 sleeved onto the support sleeve 47. The connector 46 is a rivet, and each of the two side plates 411 is provided with four rivet holes; by pressing the two ends of the rivet, the two ends of the rivet are respectively fixed into the rivet holes of the two side plates 411, thereby securely fastening the two side plates 411 together.

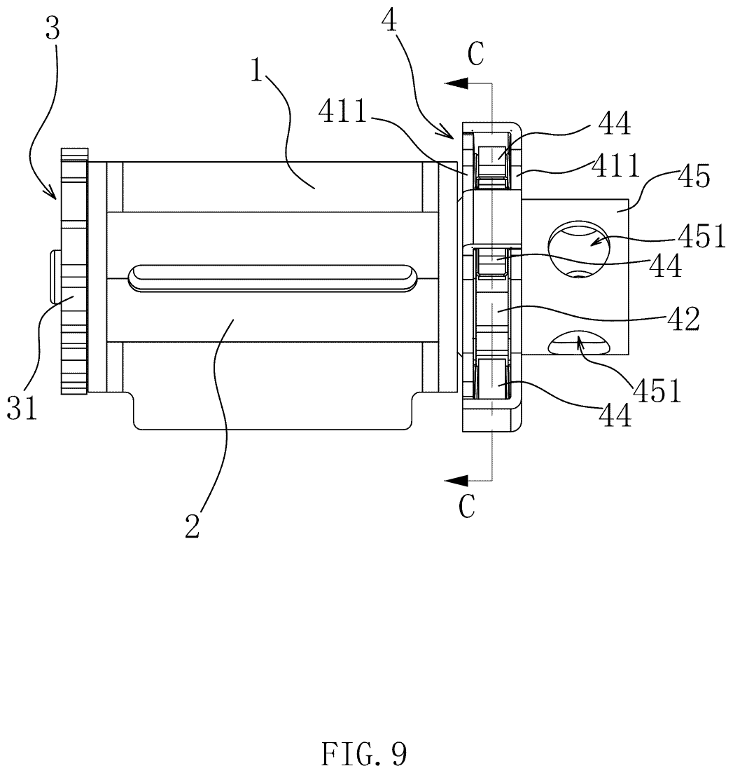

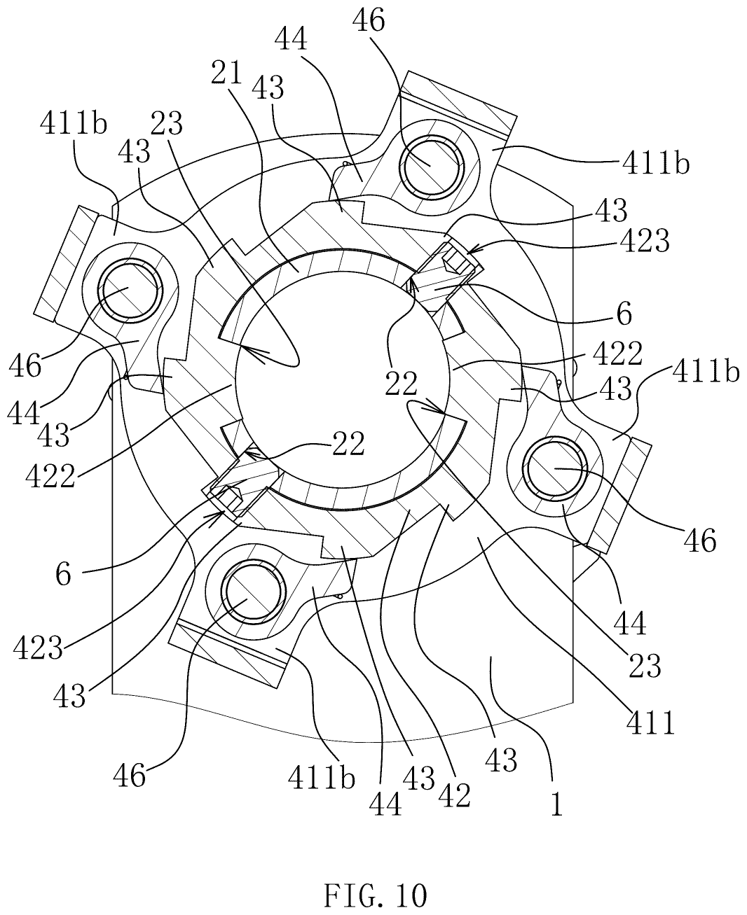

As shown in FIGS. 9 and 10, one embodiment of the mounting end 21 of the spool 2 is provided with two positioning holes 22 opposite and corresponding one-to-one with the two mounting holes 423, the fasteners 6 are cylindrical pins, and each of the fasteners 6 has an outer end with external threads capable of being threadedly connected and secured to an inner wall of the corresponding mounting hole 423, and an inner end capable of inserting into and fitting within the corresponding positioning hole 22. An outer end face of each of the cylindrical pins has a hexagonal socket, which facilitates turning the cylindrical pin with a wrench.

As shown in FIG. 10, one embodiment of two anti-rotation projections 422 are provided on an inner circumferential wall of the ratchet 42, two limit notches 23 are provided on the mounting end 21 of the spool 2, the anti-rotation projections 422 on the ratchet 42 are capable of inserting into and fitting within the limit notches 23, respectively.

Through the interaction between the anti-rotation projection 422 and the limit notch 23, the anti-rotation projection 422 is capable of working together with the fasteners 6 to securely fix a circumferential position of the ratchet teeth 43, stabilizing the installation of the ratchet 42 and ensuring consistent rotation of the spool 2 via the ratchet 42.

In use of the present winch, forward rotation of the rotatable drum 45 causes the drive bracket 41—which is fixedly connected to the rotatable drum 45—to rotate together, while the pawls 44 remaining engaged within tooth grooves of the ratchet 42, thereby driving both the ratchet 42 and the spool 2 to rotate and wind a bundling strap onto the spool 2; when the rotatable drum 45 rotates in a reverse direction, the pawls 44 slides over the ratchet 42, allowing the drive bracket 41 to rotate freely relative to the spool 2, but the spool 2 remains stationary during the reverse rotation of the rotatable drum 45 due to the uni-directional locking component 3 provided at the first end of the spool 2 and only permitting uni-directional rotation of the spool 2. Therefore, by continuously reciprocating the rotation of the rotatable drum 45 via the drive bracket 41, the spool 2 can be driven to rotate uni-directionally, gradually tightening the bundling strap and facilitating the bundling operation.

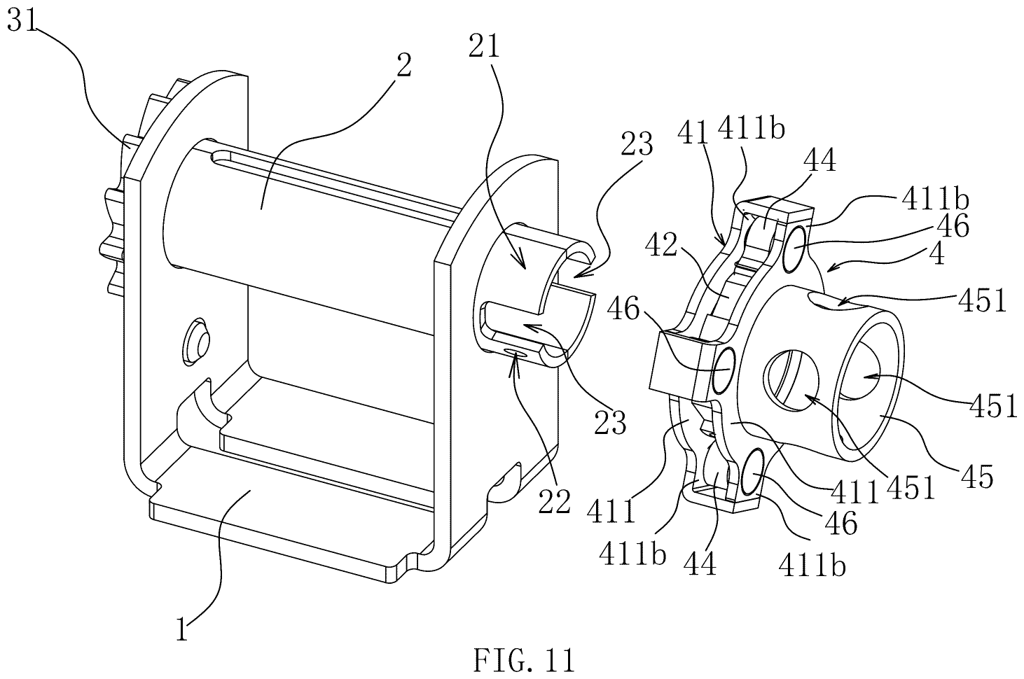

As shown in FIG. 11, when assembling one embodiment of the present winch, an operator simply needs to first assemble the drive bracket 41, the ratchet 42, the rotatable drum 45, and the pawls 44 to form the uni-directional drive component 4; next, the operator aligns the inner hole 421 of the ratchet 42 on the uni-directional drive component 4 with the spool 2 so as to sleeve the uni-directional drive component 4 onto the spool 2; afterward, the operator inserts and tightens the fastener(s) 6 into the ratchet 42 to complete the assembly process. This assembly method involves simply two steps for installing the uni-directional drive component 4 onto the spool 2, that is, sleeving the uni-directional drive component 4 onto the spool 2 via the ratchet 42, and then installing the fastener(s) 6, thereby making assembly very convenient.

### Embodiment II

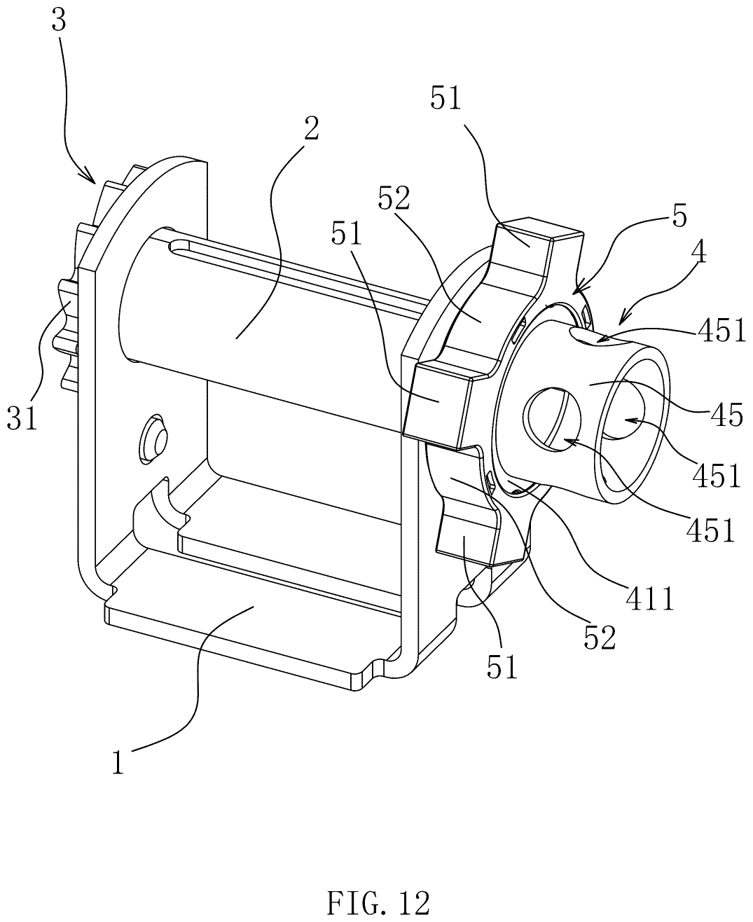

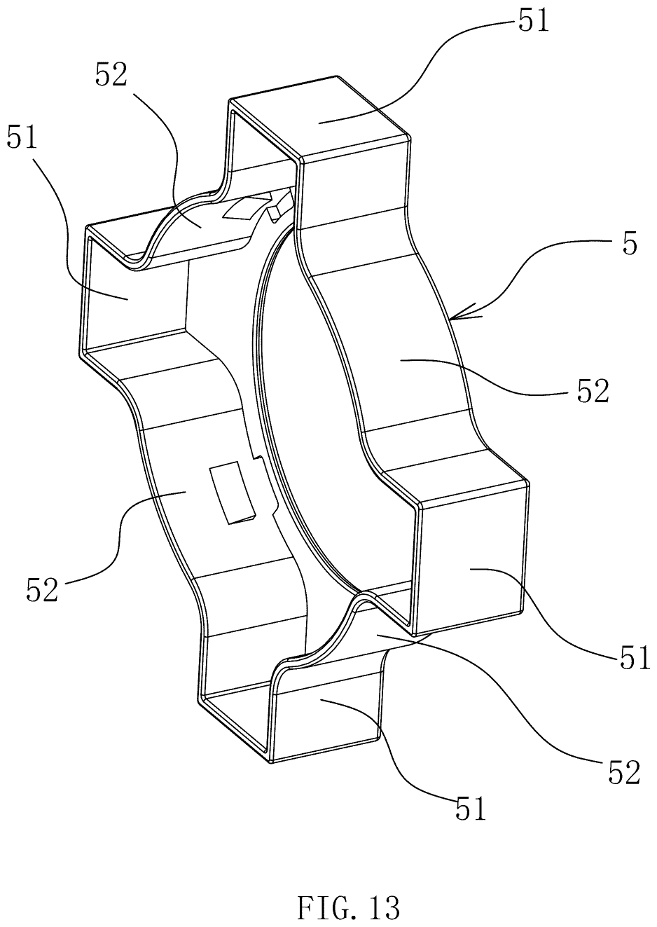

This embodiment is basically identical to Embodiment I in structure and principle, with differences as follows: as shown in FIGS. 12 and 13, an annular dust cover 5 is snap-fittedly connected to the two side plates 411, a plurality of protruded shielding portions 51 are circumferentially provided on the dust cover 5 and mutually spaced, each of the protruded shielding portions 51 corresponding to each pair of corresponding protrusions 411b on the two side plates 411 and shielding each pair of corresponding protrusions 411b, each of two adjacent protruded shielding portions 51 being connected by a curved shielding portion 52 shielding a gap between edges of the two side plates 411. The dust cover 5 serves as a dustproof effect to shield the ratchet 42 and the pawl 44 from external contaminants, thereby ensuring increased stability and reliability of the winch during use. Additionally, the dust cover 5 enhances aesthetics and safety by preventing an operator's hand from accidentally entering the drive bracket 41, thus minimizing the risk of entanglement with the moving ratchet 42 and ratchet teeth 43.

### Embodiment III

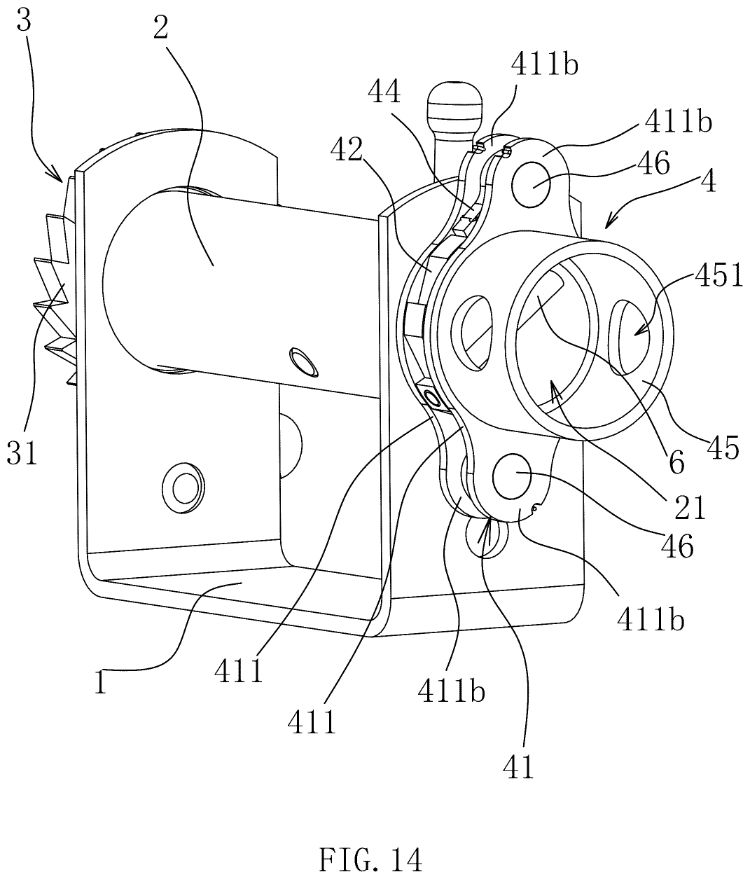

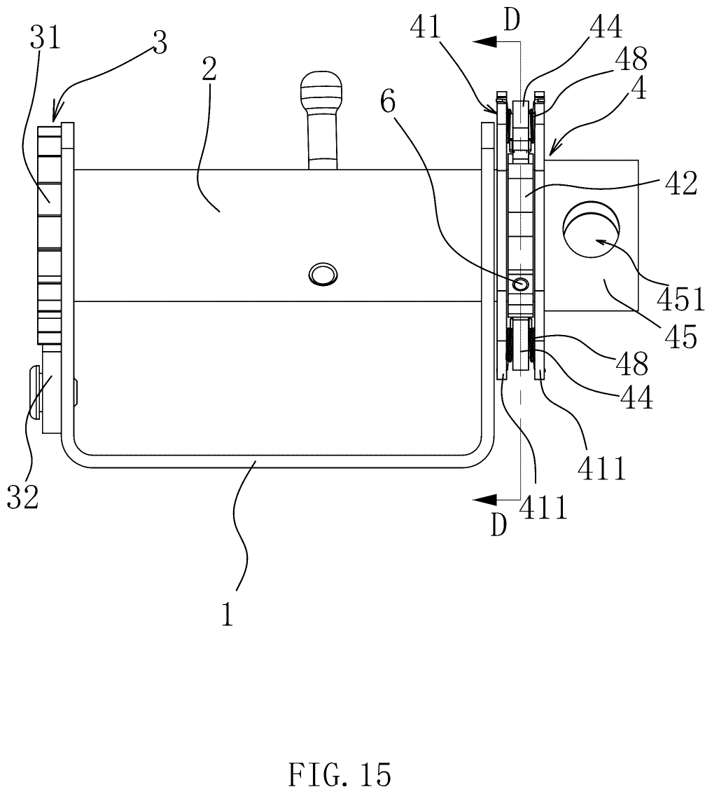

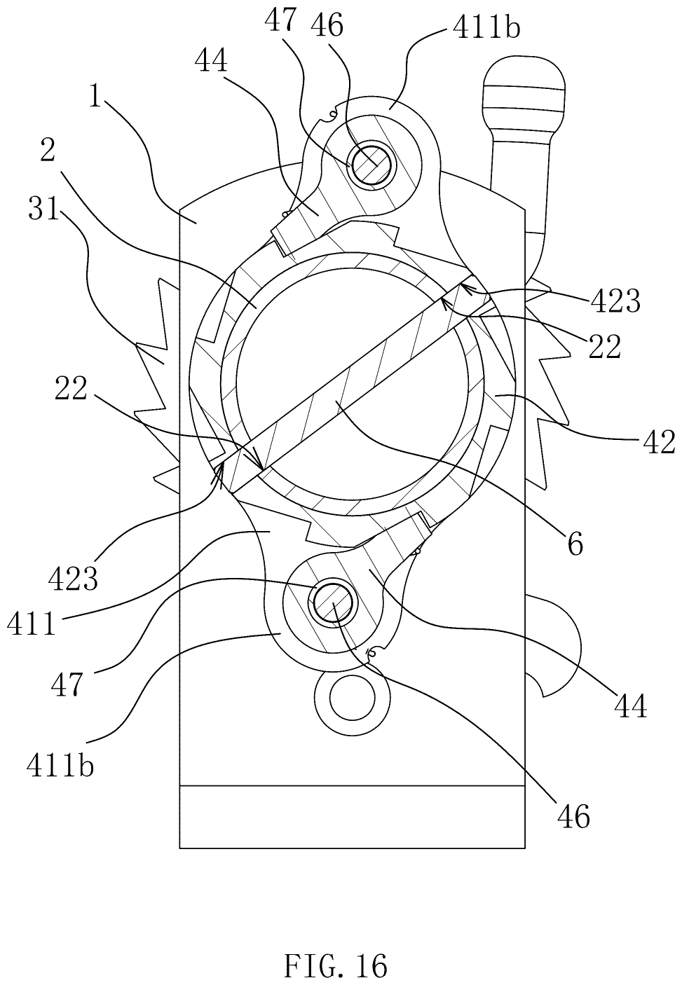

This embodiment is basically identical to Embodiment I in structure and principle, with differences as follows: as shown in FIGS. 14 to 16, there are two mounting holes 423 on the ratchet 42, and the two mounting holes 423 are located on a same diameter direction of the ratchet 42, there are two positioning holes 22 on the spool 2, and the two positioning holes 22 correspond one-to-one with the two mounting holes 423, the fastener 6 is a pin shaft, with a first end of the fastener 6 capable of being inserted into and secured within a first mounting hole 423 and a corresponding positioning hole 22, and a second end of the at least one fastener 6 capable of being inserted into and secured within a second mounting hole 423 and the corresponding positioning hole 22. This design not only stabilizes the installation of the ratchet 42, but also enhances safety, convenience, and efficiency by requiring only one fastener 6 to secure the ratchet 42.

### Embodiment IV

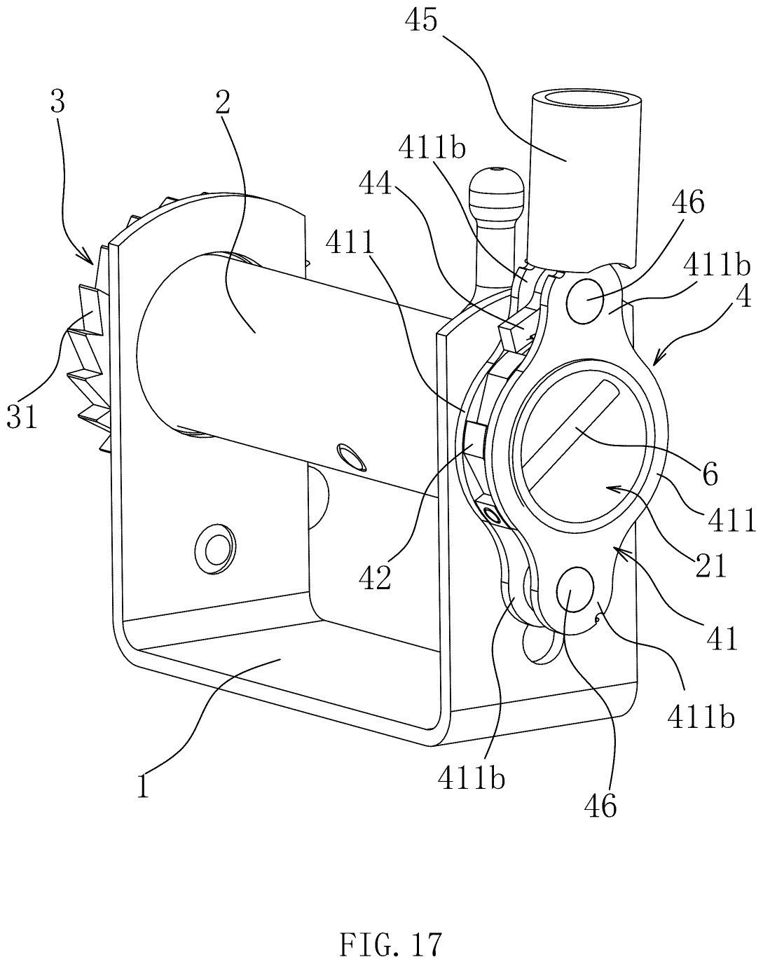

This embodiment is basically identical to Embodiment I in structure and principle, with differences as follows: as shown in FIG. 17, the rotatable drum 45 is a metal tube, the rotatable drum 45 is arranged to be perpendicular to the spool 2, and is fixedly connected to the drive bracket 41 by welding, specifically welded to the protrusions 411b of the side plates 411. During use, the winch enables continuous uni-directional rotation of the spool 2 with a simple oscillating motion of a pry bar inserted into the metal tube, making the use of the winch extremely convenient. Moreover, the metal tube is easy to manufacture, thereby reducing the manufacturing cost of the winch.

### Embodiment V

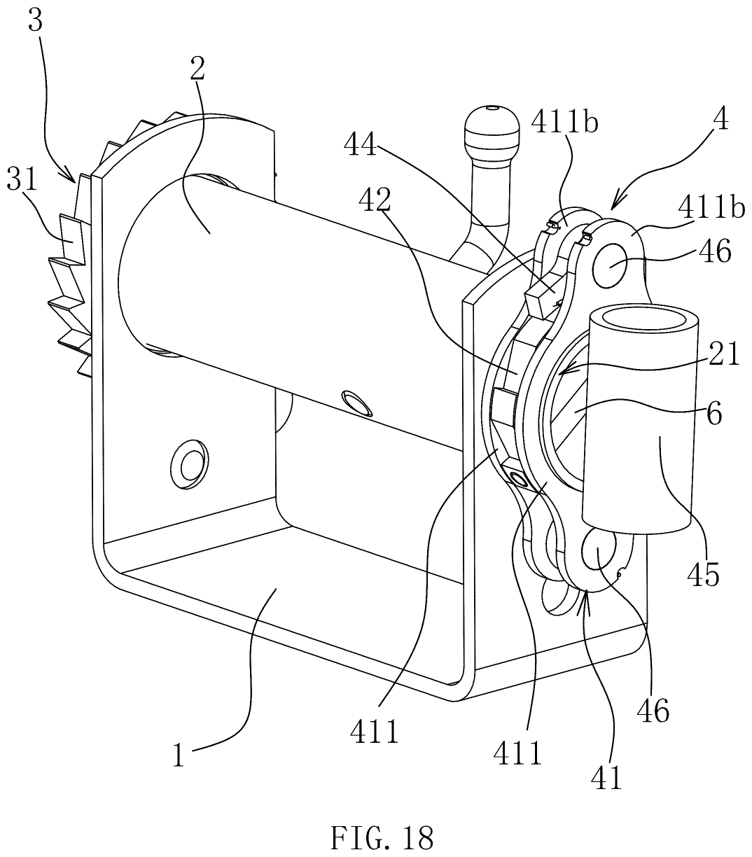

This embodiment is basically identical to Embodiment I in structure and principle, with differences as follows: as shown in FIG. 18, the rotatable drum 45 is a metal tube, the rotatable drum 45 is arranged to be perpendicular to the spool 2, and an outer side surface of the rotatable drum 45 is fixedly connected to the drive bracket 41 by welding, specifically welded to a side surface of the side plate 411. During use, the winch enables continuous uni-directional rotation of the spool 2 with a simple oscillating motion of a pry bar inserted into the metal tube, making the use of the winch extremely convenient. Moreover, the metal tube is easy to manufacture, thereby reducing the manufacturing cost of the winch.

The specific embodiments described herein are merely illustrative of the spirit of the present disclosure. A person skilled in the art to which the present disclosure pertains can make various modifications, additions, or similar substitutions to the specific embodiments described, without departing from the spirit and scope of the present disclosure defined by the appended claims.

Although the present disclosure predominantly uses terms such as main frame 1, spool 2, mounting end 21, positioning hole 22, limit notch 23, uni-directional locking component 3, anti-loosening ratchet 31, anti-loosening pawl 32, uni-directional drive component 4, drive bracket 41, side plate 411, bracket hole 411a, protrusion 411b, ratchet 42, inner hole 421, anti-rotation projection 422, mounting hole 423, ratchet tooth 43, pawl 44, rotatable drum 45, insertion hole 451, connector 46, support sleeve 47, torsion spring 48, dust cover 5, protruded shielding portion 51, curved shielding portion 52, fastener 6, etc., the use of these terms does not preclude the possibility of using other terms. The use of these terms is solely for the convenience of describing and explaining the essence of the present disclosure; interpreting them as any additional limitation would contradict the spirit of the present disclosure.

### REFERENCED PARTS

1 Main frame
2 Spool
21 Mounting end
22 Positioning hole
23 Limit notch
3 Uni-directional locking component
31 Anti-loosening ratchet
32 Anti-loosening pawl
4 Uni-directional drive component
41 Drive bracket
411 Side plate
411a Bracket hole
411b Protrusion
42 Ratchet
421 Inner hole
422 Anti-rotation projection
423 Mounting hole
43 Ratchet tooth
44 Pawl
45 Rotatable drum
451 Insertion hole
46 Connector
47 Support sleeve
48 Torsion spring
5 Dust cover
51 Protruded shielding portion
52 Curved shielding portion
6 Fastener

1. A winch, comprising:
a main frame and a spool rotatably mounted on the main frame, a first end of the spool being connected with an uni-directional locking component capable of allowing the spool to rotate only in one direction, while a second end of the spool serving as a mounting end;
wherein a uni-directional drive component assembled by a drive bracket, a ratchet, a rotatable drum, and a pawl mating with the ratchet, the rotatable drum is fixedly connected to the drive bracket, the uni-directional drive component is sleeved onto the mounting end of the spool via the ratchet, the ratchet is radially provided with at least one mounting hole, and the ratchet is fixedly connected to the mounting end of the spool by at least one fastener inserted through the at least one mounting hole.

2. The winch as claimed in claim 1,
wherein the mounting end of the spool is provided with at least one positioning hole opposite the at least one mounting hole, the at least one fastener has an outer end with external threads capable of threading into and securing inside the at least one mounting hole, and an inner end capable of inserting into and fitting within the at least one positioning hole.

3. The winch as claimed in claim 1,
wherein an anti-rotation projection is provided on an inner circumferential wall of the ratchet, a limit notch is provided on the mounting end of the spool, the anti-rotation projection on the ratchet is capable of inserting into and fitting within the limit notch.

4. The winch as claimed in claim 1,
wherein the at least one mounting hole is provided, in a quantity of 2 to 4, on an outer circumferential surface of the ratchet along a circumference of the ratchet.

5. The winch as claimed in claim 1,
wherein the drive bracket comprises two side plates arranged axially opposite each other and fixedly connected to each other, the ratchet is positioned between the two side plates, a gap between the two side plates is slightly larger than a thickness of the ratchet, each of the two side plates is provided with a bracket hole at a central part of the side plate, both bracket holes being concentric with the inner hole of the ratchet, the mounting end of the spool is rotatably inserted through the bracket holes of the two side plates.

6. The winch as claimed in claim 5,
wherein each of the two side plates has a plurality of protrusions along an edge of the side plate, protrusions on a first side plate correspond one-to-one with protrusions on a second side plate, and a connector is fixedly connected between each pair of corresponding protrusions, a support sleeve is sleeved onto the connector, the support sleeve having two end faces, a first end face abutting against the first side plate, a second end face abutting against the second side plate, the pawl is rotatably sleeved onto the support sleeve and capable of engaging in a tooth groove of the ratchet under action of a torsion spring sleeved onto the support sleeve.

7. The winch as claimed in claim 6,
wherein an annular dust cover is snap-fittedly connected to the two side plates, a plurality of protruded shielding portions are circumferentially provided on the dust cover and mutually spaced, each of the protruded shielding portions corresponding to each pair of corresponding protrusions on the two side plates and shielding each pair of corresponding protrusions, each of two adjacent protruded shielding portions being connected by a curved shielding portion shielding a gap between edges of the two side plates.

8. The winch as claimed in claim 1,
wherein there are two of the at least one mounting holes, and two mounting holes are located on a same diameter direction of the ratchet, there are two of the at least one positioning holes on the spool, and two positioning holes correspond one-to-one with the two mounting holes, the at least one fastener is a pin shaft, with a first end of the at least one fastener capable of being inserted into and secured within a first mounting hole and a corresponding positioning hole, and a second end of the at least one fastener capable of being inserted into and secured within a second mounting hole and the corresponding positioning hole.

9. The winch as claimed in claim 1,
wherein the rotatable drum is arranged to be coaxial with the spool, with one end of the rotatable drum being welded to one side of the drive bracket facing away from the main frame, and a plurality of insertion holes being provided circumferentially on the rotatable drum and mutually spaced.

10. The winch as claimed in claim 1,
wherein the rotatable drum is a metal tube, the rotatable drum is arranged to be perpendicular to the spool, and is fixedly connected to the drive bracket by welding.
